(19) United States
(12) Patent Application Publication
(10) Pub. No.: US 2012/0312393 A1
(43) Pub. Date: Dec. 13, 2012

(54) Universal Flush Valve Actuator

(76) Inventor: Chad H. Jones, Frisco, TX (US)

(21) Appl. No.: 13/158,579

(22) Filed: Jun. 13, 2011

(51) Int. Cl. F16K 31/18

(52) U.S. Cl. 137/409

(57) ABSTRACT

A flush valve actuator comprising a float, a linking arm and a flush valve seat disc that can be attached to and used with a toilet flush valve that is already installed. Also disclosed is a universal flush valve actuator kit comprising at least one float, at least one flush valve seat disc, and a plurality of linking arms that are variously attachable to differently configured toilet flush valves.

### BACKGROUND OF THE INVENTION

1. Field of the Invention

This invention relates to a flush valve actuator that is adaptable for use with toilet tanks of various sizes and configurations. The subject flush valve actuator preferably comprises a float, a linking arm and a flush valve seat disc that can be attached to and used with a toilet flush valve that is already installed. This invention also relates to a universal flush valve actuator kit comprising at least one float, at least one flush valve seat disc, and a plurality of linking arms that are variously attachable to differently configured toilet flush valves.

2. Description of Related Art

The toilet flush valves that are commonly used in residential “tank and bowl” toilets are made in at least a few different configurations that are similar to each other in function and appearance but are not identical. In the past, manufacturers and sellers of plumbing parts to building subcontractors, plumbers and do-it-yourselfers have had to provide and stock several different flush valve actuators to match up with the variously configured toilet float valves that are commercially available or, in some cases, already installed. This can result in higher manufacturing and inventory costs, an imbalance or unavailability of properly configured replacement parts, customer confusion and higher return rates for purchased parts, and consumer dissatisfaction.

### SUMMARY OF THE INVENTION

One embodiment of the invention disclosed herein is a toilet flush valve actuator that is directly attachable to and can be used with a plurality of differently configured toilet flush valves. A preferred flush valve actuator of the invention comprises apparatus suitable for releasably attaching a linking arm to one or more structural members of a toilet flush valve. One preferred embodiment of the invention is an assembly comprising at least one each of a float, a linking arm and a flush valve seat disc.

Another embodiment of the invention disclosed herein is a toilet flush valve actuator that can be configured for use with a first toilet flush valve having a first configuration, or that can be configured for use with at least a second toilet flush valve having a second configuration.

Another embodiment of the invention disclosed herein is a universal flush valve actuator kit comprising a plurality of parts that can be selectively used to configure a flush valve actuator with a particular one of a plurality of differently configured toilet flush valves. As used herein, the term “universal,” when applied to the apparatus of the invention, means that the elements of the subject kit, especially the plurality of linking arms, can be used selectively to attach a flush valve actuator to more than one of a plurality of differently configured toilet flush valves.

### BRIEF DESCRIPTION OF THE DRAWINGS

The apparatus of the invention is further described and explained in relation to the following drawings wherein:

FIG. 1 is a perspective view of one embodiment of a toilet flush valve actuator that is made in accordance with the apparatus of the invention and is positioned for installation on a toilet flush valve;

FIG. 2 is a perspective view of another embodiment of a toilet flush valve actuator that is made in accordance with the apparatus of the invention and is positioned for installation on a toilet flush valve;

FIG. 3 is an exploded perspective view of a toilet flush valve actuator made in accordance with the apparatus of the invention, the flush valve actuator further comprising a float, a linking arm and a flush valve seat disc;

FIG. 4 is a front elevation view of a linking arm suitable for use in the toilet flush valve actuator shown in FIGS. 1 and 3;

FIG. 5 is a front elevation view of another embodiment of a linking arm that is suitable for use in the toilet flush valve actuator shown in FIGS. 1 and 3; and

FIG. 6 is a front elevation view of another embodiment of a linking arm that is suitable for use in the toilet flush valve actuator shown in FIG. 2.

### DESCRIPTION OF THE PREFERRED EMBODIMENTS

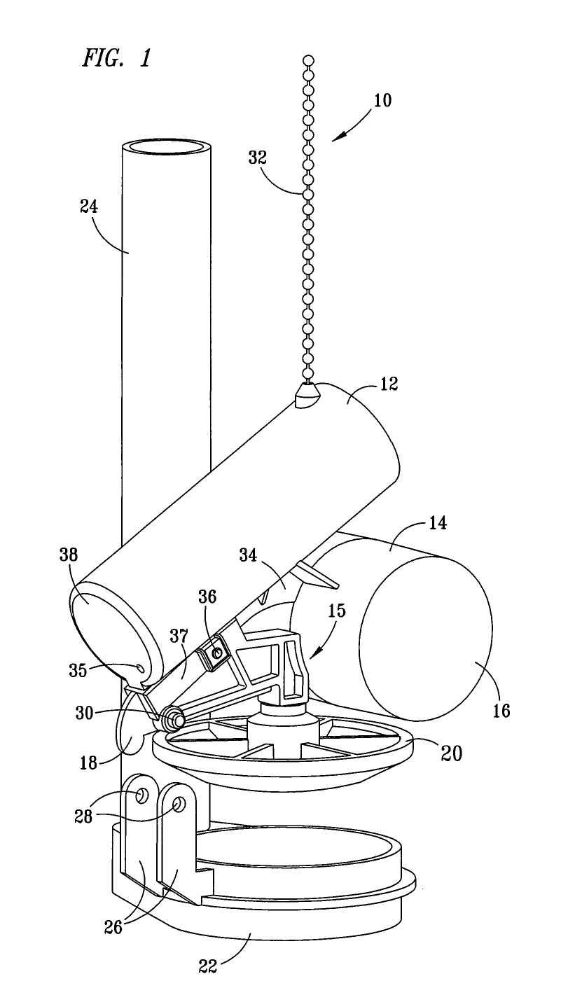

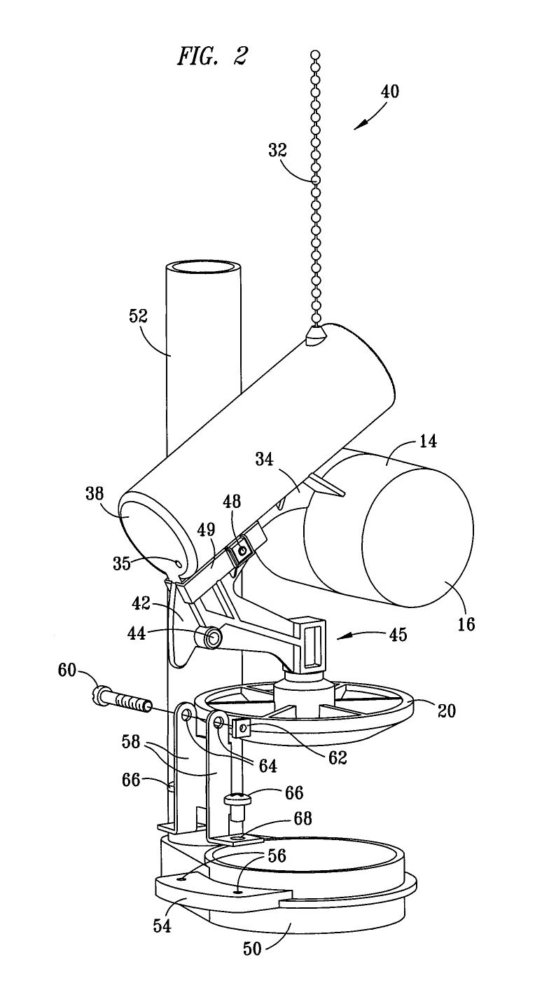

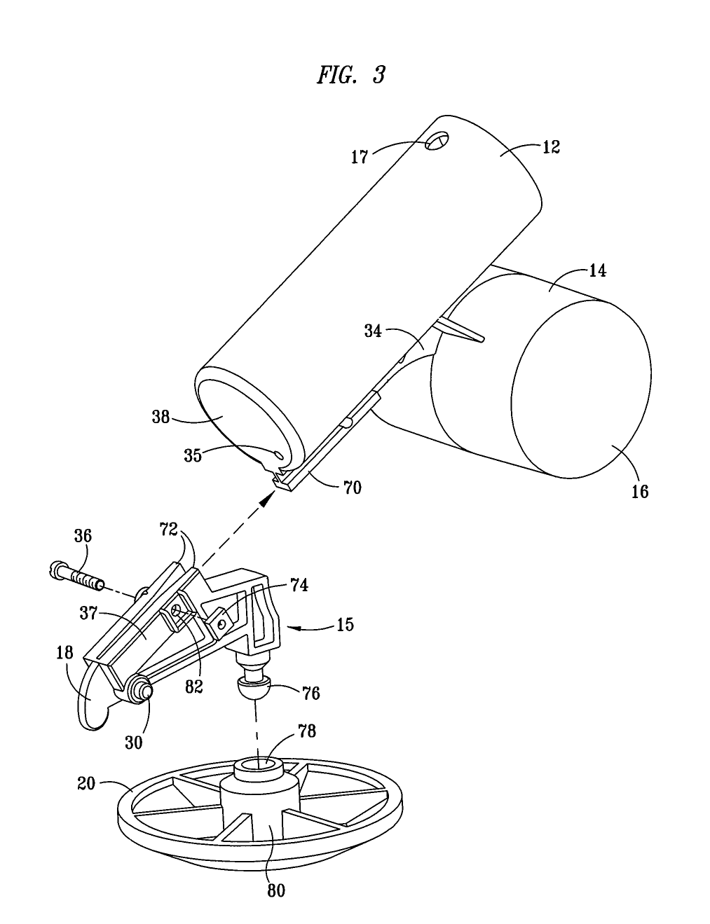

FIGS. 1 and 2 depict two embodiments of a flush valve actuator 10 of the invention just prior to installation on toilet flush valves 22, 50, respectively. Representative embodiments of flush valve actuator 10 of FIG. 1 are further depicted and described in relation to the exploded view of FIG. 3. Referring to FIG. 3, three principal components of a representative flush valve actuator include a float, a linking arm and a flush valve seal disc.

As shown, the float further comprises elongate base 34, an air chamber 14 and a partially closed, substantially cylindrical section 12. Base 34 is releasably attachable to linking arm 15 and preferably further comprises a downwardly projecting rail 70 that is slidably engageable with a slot bounded by sidewalls 72 in an upwardly inclined bracket 37 disposed on the top side of linking arm 15, where it is held in place by bolt 36 inserted through bore 82 and threaded into engagement with oppositely disposed nut 74.

Substantially cylindrical section 12 of the float is desirably connected in fixed and substantially parallel relation to the top of base 34, and is upwardly inclined over air chamber 14. Cylindrical section 12 further comprises an open upper end (a portion of which is visible through aperture 17 through the sidewall) and a substantially closed lower end 38. When configured in this manner, cylindrical section 12 will capture water stored between flushes in a toilet tank in which flush valve actuator 10 is installed Closed lower end 38 is provided with an aperture 35 of relatively smaller diameter. Water captured through the open end of upwardly inclined cylindrical section 12 will slowly drain through aperture 35 as cylindrical section 12 is elevated by chain 32 (visible in FIG. 1) during flushing.

Air chamber 14 is desirably connected in fixed relation to the longitudinal axis through base 34 at or near a forwardly extending end of base 34 and is disposed under and transversely to the open end of cylindrical section 12. When rail 70 is engaged with linking arm 15, air chamber 14 is desirably disposed forwardly of opposed surface 84 of linking arm 15, opposite its rear end 18.

Linking arm 15 preferably also comprises a downwardly projecting member 76 that is adapted to snap into engagement with recess 78 in the upwardly facing portion of hub 80 of flush valve seal disc 20 as shown in FIG. 3. The flush valve seal disk is desirably provided on its downwardly facing side with a circular, slightly convex sealing surface adapted to provide sealing engagement with the upwardly facing flush port of a toilet flush valve so that water can refill the tank after flushing. This seal is promoted by the weight of water remaining in the cylindrical section 12 of the float immediately following flushing. Although preferred structural elements for use in releasably attaching the float and flush valve seal disc 20 to a linking arm 15 to form a flush valve actuator are depicted in the drawings, it will be appreciated by those of ordinary skill in the art that other similarly effective, well known means for attaching parts can likewise be used within the scope of the invention.

The structural elements of float valve actuator 10 are, in a preferred embodiment of the invention, each unitarily molded from a moldable polymeric material or other similarly effective material that is relatively resistant to degradation in a toilet tank where chlorinated water is generally present. It will also be appreciated that portions of the float, for example, which are not unitarily molded can be separately molded and subsequently connected.

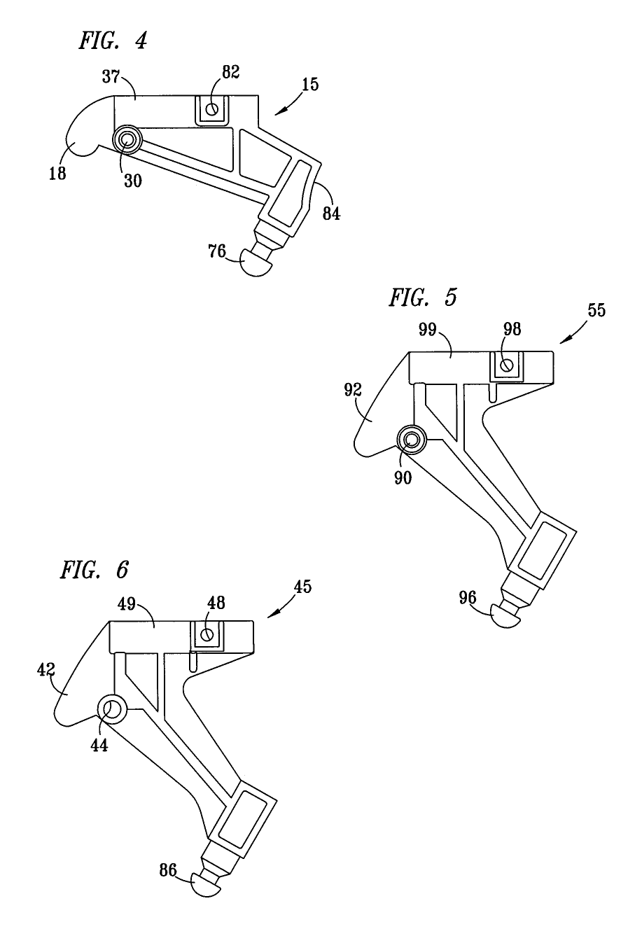

According to another embodiment of the invention, a kit can be provided with a float and flush valve seal disc as described above in combination with a plurality of linking arms that are differently configured to be easily and conveniently attachable to various toilet flush valves having slightly different configurations. Thus, for example, FIGS. 4-6 depict three different embodiments of linking arms 15, 55, 45 that can each be used to attach a flush valve actuator 10 incorporating it to one of three differently configured toilet flush valves, respectively. Many, if not most, existing residential toilet installations utilize toilet flush valves that are attachable to one of linking arms 4-6.

FIG. 4 depicts a linking arm 15 as previously described in relation to FIG. 3, that can be installed onto a toilet flush valve as shown in FIG. 1. FIG. 5 depicts a linking arm 55 that is made similarly to linking arm 15 of FIG. 4 and attaches in the same way, but has a longer body for use with a toilet flush valve (not shown) having a higher attachment point. FIG. 6 depicts linking arm 45 that is useful with a toilet flush valve as shown in FIG. 2, which has a higher attachment point, as did linking arm 55, but is configured to attach to toilet flush valve 50 (FIG. 2) using a connecting bolt 60 as further described below. Parts 92, 96, 98 and 99 of linking arm 55 (FIG. 5) and parts 42, 46, 48 and 49 of linking arm 45 (FIG. 6) generally conform to parts 18, 76, 82, and 37 of

Referring to FIG. 1, flush valve actuator 10 with elements as previously described in relation to FIG. 3 is shown in assembled form just prior to installation on toilet flush valve 22. Oppositely projecting bosses 30 are pivotably engageable inside orifices 28 in mounting brackets 26 by spreading the upright portions of the brackets and inserting bosses 30 near rear 18 of linking arm 15 into pivotable engagement with them. The installation is completed by connecting chain 32 or another similarly effective linkage to cylindrical member 12 of the float and to a flush lever that is not shown. It will be appreciated that this installation normally resides inside a toilet tank, which is not shown for simplification of the drawings.

Referring to FIG. 2, flush valve actuator 40 is shown in assembled form just prior to installation on toilet flush valve 50. Mounting brackets 58 attached to mounting pad 54 of toilet flush valve 50 are also attachable to oppositely projecting bosses having a through-bore 44 by use of bolt 60 and nut 62, which permit pivotable movement between toilet valve actuator 40 and toilet flush valve 50 during flushing. The installation is completed by connecting chain 32 of the float to a flush lever as described above. As before, it will be appreciated that this installation normally resides inside a toilet tank, which is not shown to simplify the drawings.

Other alterations and modifications of the invention will likewise become apparent to those of ordinary skill in the art upon reading this specification in view of the accompanying drawings, and it is intended that the scope of the invention disclosed herein be limited only by the broadest interpretation of the appended claims to which the inventor is legally entitled.

I claim:

1. A universal flush valve actuator kit comprising a plurality of parts that can be selectively used to configure a flush valve actuator for attachment to and use with a particular one of a plurality of differently configured toilet flush valves, said parts comprising:
a float, a plurality of linking arms and a flush valve seat disc, wherein each of the plurality of linking arms is different and wherein each of the linking arms is configured to be selectively attachable to the float and to the flush valve seat disc to make the flush valve actuator releasably attachable to a different one of the plurality of differently configured toilet flush valves.

2. The kit of claim 11 wherein the float further comprises an elongate base, an enclosed air chamber connected in fixed relation to the base near a forwardly extending end of the base, and a substantially cylindrical section connected in fixed and substantially parallel relation to the base, the substantially cylindrical section further comprising an open end with a first diameter and a substantially closed end, the open end being inclined upwardly over a portion of the enclosed air chamber.

3. The flush valve actuator of claim 2 wherein the substantially closed end of the substantially cylindrical section further comprises an aperture disposed proximally to the base, the aperture having a second diameter that is substantially smaller than the first diameter of the open end.

4. The flush valve actuator of claim 2 wherein an attachment point for a toilet flush lever assembly is provided near the open end of the substantially cylindrical section.

5. The flush valve actuator of claim 1 wherein each linking arm further comprises a bracket member having an upwardly inclined top section that is attachable to the float.

6. The flush valve actuator of claim 5 wherein the upwardly inclined top section slidably engages the base of the float.

7. The flush valve actuator of claim 1 wherein each linking arm comprises an underside having a downwardly facing projection that is engageable with an upwardly facing recess in the flush valve seat disc.

8. The flush valve actuator of claim 1 wherein the linking arm comprises a pair of transverse and oppositely projecting bosses that are insertable into releasable engagement with a toilet flush valve.

9. The flush valve actuator of claim 1 wherein the linking arm comprises a transverse bore through which a bolt is insertable to permit releasably engage a toilet flush valve.

10. The flush valve actuator of claim 1 wherein the flush valve seat disc is configured to provide a liquid-tight seal when seated against a toilet flush valve installed in a toilet tank.

11. A flush valve actuator that is releasably attachable to a first toilet flush valve, said flush valve actuator comprising:
an assembly further comprising at least a float, a first linking arm and a flush valve seat disc that are interconnectable to avoid substantial movement between them during use, said flush valve actuator being configured to permit the first linking arm to be interchanged with at least a second linking arm that is different from the first linking arm to make said flush valve actuator releasably attachable to a second toilet flush valve that is different from the first toilet flush valve.

12. The flush valve actuator of claim 11 in combination with a plurality of differently configured linking arms that are each configured to be releasably attachable to a differently configured toilet flush valve.

13. The flush valve actuator of claim 11 wherein the float further comprises an elongate base, an enclosed air chamber connected in fixed relation to the base near a forwardly extending end of the base, and a substantially cylindrical section connected in fixed and substantially parallel relation to the base, the substantially cylindrical section further comprising an open end with a first diameter and a substantially closed end, the open end being inclined upwardly over a portion of the enclosed air chamber.

14. The flush valve actuator of claim 13 wherein the substantially closed end of the substantially cylindrical section further comprises an aperture disposed proximally to the base, the aperture having a second diameter that is substantially smaller than the first diameter of the open end.

15. The flush valve actuator of claim 13 wherein an attachment point for a toilet flush lever assembly is provided near the open end of the substantially cylindrical section.

16. The flush valve actuator of claim 1 wherein each of the first and second linking arms further comprises a bracket member having an upwardly inclined top section that is attachable to the float.

17. The flush valve actuator of claim 16 wherein the upwardly inclined top section slidably engages the base of the float.

18. The flush valve actuator of claim 11 wherein each of the first and second linking arms comprises an underside having a downwardly facing projection that is engageable with an upwardly facing recess in the flush valve seat disc.

19. The flush valve actuator of claim 11 wherein the first linking arm comprises a pair of transverse and oppositely projecting bosses that are insertable into releasable engagement with the first toilet flush valve.

20. The flush valve actuator of claim 11 wherein the at least a second linking arm comprises a transverse bore through which a bolt is insertable to releasably engage the second toilet flush valve.

21. The flush valve actuator of claim 11 wherein the flush valve seat disc is configured to provide a liquid-tight seal when seated against either of the first toilet flush valve or the at least a second toilet flush valve when the respective flush valve is installed in a toilet tank.
